(19) United States
(12) Patent Application Publication
(10) Pub. No.: US 2012/0317034 A1
(43) Pub. Date: Dec. 13, 2012

(54) TRANSPARENT VIRTUAL CURRENCY USING VERIFIABLE TOKENS

(75) Inventors: Saikat Guha, Bangalore (IN); Raghav Bhaskar, Bangalore (IN); Srivatsan Laxman, Bangalore (IN); Prasad Naldurg, Karnataka (IN)

(73) Assignee: MICROSOFT CORPORATION, Redmond, WA (US)

(21) Appl. No.: 13/159,224

(22) Filed: Jun. 13, 2011

(51) Int. Cl. G06Q 20/00

(52) U.S. Cl. 705/65

(57) ABSTRACT

Users make online purchases using a virtual currency. A series of secret encryption keys is generated, where each key in the series is associated with a different epoch. A token tracking table is initialized. Whenever real currency is received from a user wanting to purchase tokens, a semantically secure encryption method is used in conjunction with the secret encryption key in the series that is associated with the current epoch to generate a set of encrypted tokens which includes one or more encrypted paid tokens. The set of encrypted tokens is sent to the user wanting to purchase tokens, and each encrypted paid token in the set is entered into the token tracking table, where the entry for each encrypted paid token includes information specifying that the token has not yet been spent and has not yet been encashed.

### BACKGROUND

The Internet is a global data communications system that serves billions of users and billions of online businesses worldwide. The Internet provides users access to a vast array of online resources and services, including those provided by the World Wide Web. For example, the Internet provides users with the ability to shop for and make online purchases of a limitless array of virtual goods and services, and real goods and services. The online shopping market has seen phenomenal growth in recent years, thanks to the ubiquity of the Internet and the World Wide Web, the ubiquity of personal computers and laptop computers, the fast growing popularity of Internet-enabled video game consoles, and the fast growing popularity of Internet-enabled handheld computing devices such as smartphones and tablet computers. Both virtual currency and real currency form the basis of the online shopping economy.

### SUMMARY

This Summary is provided to introduce a selection of concepts, in a simplified form, that are further described hereafter in the Detailed Description. This Summary is not intended to identify key features or essential features of the claimed subject matter, nor is it intended to be used as an aid in determining the scope of the claimed subject matter.

Transparent virtual currency technique embodiments described herein generally allow users to make online purchases using a virtual currency. In one exemplary embodiment a series of secret encryption keys is generated, where each key in the series is associated with a different epoch in an ongoing sequence of epochs. A token tracking table is initialized which tracks the status of all the tokens which are issued to the users. Whenever an amount of real currency is received from a user wanting to purchase tokens, a semantically secure encryption method is used in conjunction with the secret encryption key in the series that is associated with the current epoch to generate a set of encrypted tokens which includes one or more encrypted paid tokens whose combined real currency value equals the amount of real currency received from the user wanting to purchase tokens. The set of encrypted tokens is sent to the user wanting to purchase tokens, and each encrypted paid token in the set is entered into the token tracking table, where the entry for each encrypted paid token includes information specifying that the token has not yet been spent and has not yet been encashed.

In another exemplary embodiment a public commitment key having been generated and subsequently published by a trusted third party is received. The trusted third party generated this key by running a setup function of a secure additively homomorphic commitment method. A token tracking table is initialized which tracks the status of all the tokens which are issued to the users. Whenever an amount of real currency is received from a user wanting to purchase tokens, a commit function of the commitment method is run in conjunction with the public commitment key to generate a set of committed tokens which includes one or more committed paid tokens whose combined real currency value equals the amount of real currency received from the user wanting to purchase tokens. The set of committed tokens is sent to the user wanting to purchase tokens, and each committed paid token in the set is entered into the token tracking table, where the entry for each committed paid token includes information specifying that the token has not yet been spent and has not yet been encashed.

### DESCRIPTION OF THE DRAWINGS

The specific features, aspects, and advantages of the transparent virtual currency (TVC) technique embodiments described herein will become better understood with regard to the following description, appended claims, and accompanying drawings where:

FIG. 1 is a diagram illustrating an exemplary embodiment, in simplified form, of an architectural framework for implementing the TVC technique embodiments described herein.

FIGS. 2A-2C are a flow diagram illustrating one embodiment, in simplified form, of a process for allowing users to make online purchases using a virtual currency.

FIGS. 3A-3C are a flow diagram illustrating another embodiment, in simplified form, of a process for allowing users to make online purchases using a virtual currency.

FIG. 4 is a diagram illustrating a simplified example of a general-purpose computer system on which various embodiments and elements of the TVC technique, as described herein, may be implemented.

### DETAILED DESCRIPTION

In the following description of transparent virtual currency (TVC) technique embodiments reference is made to the accompanying drawings which form a part hereof, and in which are shown, by way of illustration, specific embodiments in which the TVC technique can be practiced. It is understood that other embodiments can be utilized and structural changes can be made without departing from the scope of the TVC technique embodiments.

The term “real currency” is used herein to refer to money which can be exchanged as legal tender between parties, where the money can be in either a physical form (such as coins, banknotes, and the like) or a non-physical form (such as electronic money, also known as electronic cash/currency, digital money, and digital cash/currency). The term “gaming platform” is used herein to refer to an online service which offers online games (hereafter simply referred to as “games”) and related virtual goods to its users. It will be appreciated that gaming platforms include, but are not limited to, dedicated gaming platforms (such as Windows Live® (a registered trademark of Microsoft Corporation) and Xbox LIVE® (a registered trademark of Microsoft Corporation), among others) and social networking platforms (such as Facebook, among others). The term “real goods” is used herein to refer to physical objects and services. The term “virtual goods” is used herein to refer to non-physical objects and services which exist purely in digital form and are purchased for use in online communities or games. Virtual goods are commonly sold by gaming platforms, third-party online game developers (hereafter simply referred to as “game developers”), community websites, and the like. Exemplary virtual goods include, but are not limited to, virtual gifts, games, in-game purchases, and customizations for avatars (such as clothing, pets, accessories, and the like).

### 1.0 Online Shopping

As described heretofore, the Internet provides users with the ability to shop for and make online purchases of a limitless array of virtual goods and real goods. The aforementioned phenomenal growth in the online shopping market is additionally fueled by the recent growth in the popularity of online gaming. The sale of virtual goods on gaming platforms is fast becoming a leading source of revenue for both the game developers and the gaming platforms. As is appreciated in the art of online shopping, the online purchase of virtual goods can generally be made using a combination of virtual currency and real currency. Virtual currency generally takes the form of tokens (also known as “credits”). Tokens can be purchased from a given gaming platform by the users. Some gaming platforms also issue tokens to certain users free of charge. More particularly, a given gaming platform can issue tokens to certain users free of charge on a promotional basis to encourage user participation. A given gaming platform can also periodically issue tokens to certain users free of charge as a reward for customer loyalty, or as a reward for performing prescribed tasks for the platform (such as testing a new game, or testing a new game feature, or the like), or as a reward for achieving prescribed goals within a prescribed game. A vast majority of the gaming platforms in existence now support both tokens which are purchased by users and tokens which are issued to users free of charge.

After a user either purchases tokens from a given gaming platform or receives them from the gaming platform free of charge as a reward, the user can spend the tokens in various ways such as purchasing virtual goods or real goods from the gaming platform, or purchasing virtual goods or real goods from a game developer, among others. This unified view of tokens holds a lot of promise since it provides users with a seamless way of paying for all sorts of commodities available on the gaming platform. It also encourages regular user participation on the gaming platform. However, since not all tokens entail a “real currency” trail, the gaming platform has to be careful when it redeems tokens. More particularly, the gaming platform has to distinguish between the tokens which users have purchased using real currency, and the tokens which are issued to users free of charge.

### 2.0 Transparent Virtual Currency (TVC) Using Verifiable Tokens

The TVC technique embodiments described herein are generally applicable to allowing users of a gaming platform to make online purchases from both game developers and the gaming platform using a virtual currency. Such purchases generally result in various transactions taking place between the users, game developers and gaming platform. These transactions can be thought of as a virtual economy.

The TVC technique embodiments described herein are advantageous for various reasons including, but not limited to, the following. As will be appreciated from the more detailed description that follows, the TVC technique embodiments are scalable to support a large number of different users and game developers. The TVC technique embodiments are also computationally efficient. The TVC technique embodiments also provide for transparent accounting of the transactions in the virtual economy. The TVC technique embodiments also impose minimal trust requirements on the gaming platform. The TVC technique embodiments also allow the users and game developers to implicitly trust the gaming platform to correctly account for and share revenues fairly with the game developers. In other words the users and game developers can rest assured that the gaming platform pays the game developers their fair share of the real currency value of tokens which the game developers collect from the users and subsequently send back to the gaming platform for encashment.

As will be also appreciated from the more detailed description that follows, the TVC technique embodiments described herein are further advantageous in that they ensure that all real currency in the virtual economy is accounted for. More particularly, the TVC technique embodiments ensure that the real currency disbursed by the gaming platform equals the real currency taken in by the gaming platform after adjusting for the gaming platform's profit margin. The TVC technique embodiments also ensure that even in the presence of the aforementioned two different types of tokens in the virtual economy (i.e., tokens which are purchased from the gaming platform by users, and tokens which are issued by the gaming platform to users free of charge), the game developers cannot distinguish between these types of tokens, thus ensuring that the promise of seamless payments through tokens is not violated.

As will also be appreciated from the more detailed description that follows, in the TVC technique embodiments described herein the virtual economy is controlled by the gaming platform. However, despite this fact, the TVC technique embodiments also ensure that the users and game developers do not lose real currency even in the situation where the gaming platform experiences a failure or malfunction. Additional advantages of the TVC technique embodiments are described hereafter.

### 2.1 Architectural Framework and Terminology

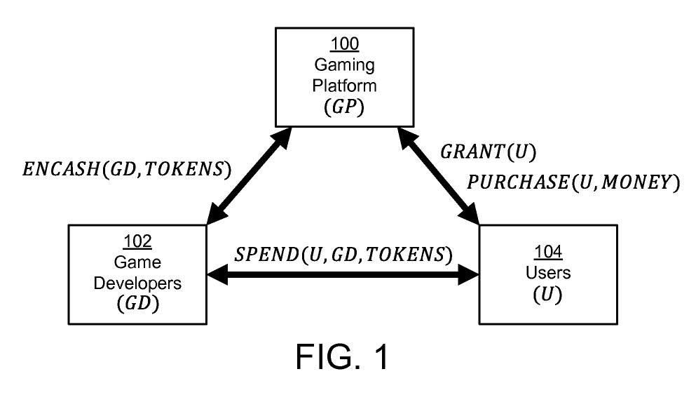

FIG. 1 illustrates an exemplary embodiment, in simplified form, of an architectural framework for implementing the TVC technique embodiments described herein. As exemplified in FIG. 1, the TVC technique embodiments generally include three different actors, namely a gaming platform (GP) 100, one or more game developers (GD) 102, and one or more users (U) 104. The gaming platform generally owns and maintains the infrastructure for a gaming ecosystem. Exemplary gaming platforms 100 have been described heretofore. The game developers 102 are registered with the gaming platform 100 and use the gaming platform's infrastructure to host their games. Exemplary game developers 102 include companies like Zynga, among others. As is appreciated in the art of online gaming, Zynga is the maker of games like Farmville™ (a trademark of Zynga Game Network Inc.), Cityville and Mafia Wars™ (a trademark of Zynga Game Network Inc.), each of which are hosted on the Facebook gaming platform. The users 104 are also registered with the gaming platform 100 and interface with the games provided by the game developers 102. It is in the business interest of both the gaming platform 100 and the game developers 102 to provide an interesting and compelling gaming experience for the users 104.

Referring again to FIG. 1, the TVC technique embodiments described herein assume that tokens are the base unit of virtual currency in the gaming ecosystem. As will be described in more detail hereafter, the gaming platform 100 issues and regulates the tokens in the gaming ecosystem. As described heretofore, users 104 who are playing a game on the gaming platform can either purchase tokens from the gaming platform, or receive tokens from the gaming platform free of charge as a reward. Thus, in the TVC technique embodiments described herein each individual token can be either a free token or a paid token. Free tokens are tokens which are issued to the users by the gaming platform free of charge in the manner and based on the circumstances described heretofore. Each free token is thus assigned a real currency value of zero monetary units. As will be described in more detail hereafter, paid tokens are tokens which are purchased by the users from the gaming platform using real currency. There is a fixed (and previously published) price at which the users can purchase tokens from the gaming platform. For convenience, in the more detailed description that follows each paid token is assigned a real currency value of one monetary unit (e.g., once cent).

Referring again to FIG. 1, the game developers 102 can offer virtual goods for sale within their games to the users 104. The users can redeem (i.e., spend) tokens which they have accumulated to purchase such virtual goods from either the gaming platform 100 or the game developers. The users can also redeem tokens to purchase real goods from either the gaming platform or the game developers.

Referring again to FIG. 1 and as described heretofore, the TVC technique embodiments described herein are advantageous in that the game developers 102 cannot distinguish between paid tokens and free tokens. As a result, the game developers are unable to differentiate between users 104 who are paying with free tokens and users who are paying with paid tokens. Thus, the game developers are unable to treat users who are paying with paid tokens preferentially. Another advantage of the TVC technique embodiments is that the game developers and users transact using just tokens (i.e., the game developers and users do not transact using real currency). After a given game developer collects tokens from users that purchased virtual goods in the game developer's games, the game developer can send the collected tokens back to the gaming platform 100 and encash them for real currency. Yet another advantage of the TVC technique embodiments is that the gaming platform pays the game developer real currency just for the paid tokens which are received from the game developer; no real currency is paid to the game developer for the free tokens he sends back to the gaming platform. Additionally, the gaming platform withholds (towards its own profits) a fixed fraction of the real currency value of paid tokens it receives from the gaming platform for encashment, where this fixed fraction withholding is the profit margin of the gaming platform. This fixed fraction withholding by the gaming platform is thus hereafter sometimes referred to as “PROFIT”. It will be appreciated that PROFIT is herein assumed to be published by the gaming platform.

Referring again to FIG. 1, a description of the transactions that take place between the actors 100/102/104 in the TVC technique embodiments described herein will now be provided. An individual token (which as descried heretofore can be either a free token or a paid token) is hereafter sometimes referred to as a “TOKEN”. A set of tokens (which can include either one or more free tokens, or one or more paid tokens, or any combination of free and paid tokens) is hereafter sometimes referred to as “TOKENS”. A given amount of real currency (which is valued in monetary units) is hereafter sometimes referred to as “MONEY”. Various types of transactions can take place between the actors including, but not limited to, a GRANT(U) transaction, a PURCHASE(U,MONEY) transaction, a SPEND(U,GD,TOKENS) transaction and an ENCASH(GD,TOKENS) transaction. Each of these transactions will now be described in more detail.

Referring again to FIG. 1, the GRANT(U) transaction generally takes place between the gaming platform (GP) 100 and the users (U) 104, and is associated with the gaming platform sending free (i.e., zero-value) tokens to the users. More particularly, the GRANT(U) transaction is initiated by the gaming platform and sends TOKENS having a real currency value of MONEY=0 to a given user based on the circumstances described heretofore. The PURCHASE(U,MONEY) transaction also generally takes place between the gaming platform and the users, and is associated with the users purchasing tokens from the gaming platform. More particularly, the PURCHASE(U,MONEY) transaction is initiated by a given user when the user pays MONEY=X to the gaming platform in order to purchase tokens. In exchange for this payment the gaming platform sends TOKENS having a real currency value of MONEY=X to the user.

Referring again to FIG. 1, the SPEND(U,GD,TOKENS) transaction generally takes place between the users 104 and the game developers (GD) 102, and is associated with the users purchasing virtual goods inside games they are playing. More particularly, the SPEND(U,GD,TOKENS) transaction is initiated by a given user when the user pays TOKENS to a given game developer in order to purchase virtual goods inside of a game they are playing which was developed by the game developer. The ENCASH(GD,TOKENS) transaction generally takes place between the game developers and the gaming platform 100, and is associated with the game developers sending tokens they have collected from one or more users back to the gaming platform and encashing them for real currency. More particularly, the ENCASH(GD,TOKENS) transaction is initiated by a given game developer when the game developer sends TOKENS to the gaming platform in order to encash the TOKENS. In exchange for the TOKENS the gaming platform receives from the game developer, the gaming platform sends MONEY=((1−PROFIT)×TOKENS) to the game developer.

It will be appreciated that the TOKENS can be implemented in various ways. In an exemplary embodiment of the TVC technique described herein each token is represented by a bit string, and it is the bit string which is explicitly exchanged between the actors during the various transactions described heretofore.

### 2.2 Security Properties

The TVC technique embodiments described herein generally provide for three different security properties, namely conservation, indistinguishability and non-repudiation. Each of these properties will now be described in more detail.

### 2.2.1 Conservation

Referring again to FIG. 1, the total value of all the real currency that all the users 104 have paid to the gaming platform 100 through all of the PURCHASE(U,MONEY) transactions is hereafter sometimes referred to as “MONEYIN”. The total value of all the real currency that the gaming platform has paid-out to the game developers 102 through all of the ENCASH(GD,TOKENS) transactions is hereafter sometimes referred to as “MONEYOUT”. A set of one or more currently valid (e.g., unspent) tokens is hereafter sometimes referred to as “VALIDT”. A set of one or more tokens that has already been encashed by a game developer is hereafter sometimes referred to as “ENCASHEDT”. The real currency value of a given set of tokens can be given by the function Value(•).

Referring again to FIG. 1, the conservation security property of the TVC technique embodiments described herein ensures that all of the real currency that is transacted between the actors 100/102/104 can be properly accounted for. To this end, the TVC technique embodiments ensure that a framework-wide invariant which can be given by the following equation holds at all times:

MONEYIN=MONEYOUT+Value(VALIDT)+PROFIT* Value(ENCASHEDT), (1)

where MONEYOUT can be given by the following equation:

MONEYOUT=(1−PROFIT)*Value(ENCASHEDT). (2)

The conservation security property can in-turn be satisfied if the material implication TOKENS←PURCHASE(U,MONEY) satisfies the following equation:

Value(TOKENS)=MONEY, (3)

and the material implication MONEY←ENCASH(GD,TOKENS) satisfies the following equation:

MONEY=(1−PROFIT)*Value(TOKENS). (4)

In other words, the conservation security property makes it possible for the actors to validate that the value of the tokens encashed by the game developers is exactly equal to the real currency spent by the users of their games, after adjusting for the gaming platform's published profit margin, and after accounting for any unspent tokens that the users still have in their accounts.

It is noted that both the game developers and the gaming platform are naturally incentivized to detect any fraud by the users involving their attempted use of invalid (e.g., already spent) tokens. Thus, the TVC technique embodiments described herein are able enforce the conservation property assuming that the gaming platform truthfully (and in a timely manner) helps the game developers indentify any invalid tokens that the users might attempt to spend in a game they are playing. The conservation security property is advantageous for various reasons including, but not limited to, the fact that neither the game developers nor the users have to trust the gaming platform implicitly in order to verify that they are being treated fairly with regard to transaction accounting.

### 2.2.2 Indistinguishability

Referring again to FIG. 1, the indistinguishability security property of the TVC technique embodiments described herein ensures that the game developers 102 cannot distinguish between paid tokens and free tokens in the SPEND(U,GD,TOKENS) transaction. Thus, the indistinguishability security property ensures that the game developers treat the users 104 fairly by not giving users who spend paid tokens in a game they are playing preferential treatment over users who spend free tokens. The TVC technique embodiments satisfy this property in the following manner. The TVC technique embodiments prevent the game developers from computing the real currency value of tokens that are spent by the users in individual SPEND(U,GD,TOKENS) transactions. The TVC technique embodiments also allow the game developers to check the correctness of real currency received from the gaming platform 100 in individual ENCASH(GD,TOKENS) transactions so long as the gaming developers cannot eventually infer the real currency value of tokens that are spent in individual SPEND(U,GD,TOKENS) transactions.

### 2.2.3 Non-Repudiation

Generally speaking and referring again to FIG. 1, the non-repudiation security property of the TVC technique embodiments described herein prevents any actor 100/102/104 from repudiating any transaction after-the-fact. In other words, the non-repudiation security property of the TVC technique embodiments ensures that none of the actors can deny spending, receiving or encashing tokens. More particularly and by way of example, but not limitation, in any PURCHASE(U,MONEY) transaction between a user 104 and the gaming platform 100, the non-repudiation security property of the TVC technique embodiments does not allow the user to deny receiving the paid tokens from the gaming platform. In any SPEND(U,GD,TOKENS) transaction between a user and a given game developer 102, the non-repudiation security property of the TVC technique embodiments does not allow the user to deny having spent the tokens, and also do not allow the game developer to deny having received the tokens from the user. In any ENCASH(GD,TOKENS) transaction between a given game developer and the gaming platform, the non-repudiation security property of the TVC technique embodiments does not allow the game developer to deny having received the tokens which were sent by the game developer. It is noted that in the PURCHASE(U,MONEY) and ENCASH(GD,TOKENS) transactions, the non-repudiation security property guarantees for receipt of the real currency are regulated by infrastructure support that is external to the TVC technique embodiments (such as bank transaction records, among other things).

### 2.3 Process Framework

This section describes various embodiments of a process for allowing users to make online purchases using a virtual currency. In one embodiment the process is implemented using an eventual verification scheme; this particular embodiment is hereafter referred to as the “eventual verification scheme embodiment” of the TVC technique described herein. In another embodiment the process is implemented using a timely verification scheme; this particular embodiment is hereafter referred to as the “timely verification scheme embodiment” of the TVC technique. In yet another embodiment the process is implemented using a timely verification scheme that includes non-repudiation; this particular embodiment is hereafter referred to as the “non-repudiation scheme embodiment” of the TVC technique. Each of these embodiments will now be described in more detail.

### 2.3.1 Eventual Verification Scheme

This section presents a description of the eventual verification scheme embodiment of the TVC technique described herein. As will be appreciated from the more detailed description that follows, the eventual verification scheme embodiment achieves the conservation security property at all times, and achieves the indistinguishability security property during a fixed time period T which is hereafter sometimes referred to as an “epoch”. However, it is noted that the conservation and indistinguishability security properties can be verified by the users and game developers just at the end of a given epoch T. Once one or more tokens are verified, indistinguishability is lost for transactions in the past. The eventual verification scheme embodiment is advantageous in that it is easy to implement and very computationally efficient.

The eventual verification scheme embodiment of the TVC technique described herein utilizes a semantically secure encryption method which is hereafter sometimes referred to as “E_{K}(•)”, where K denotes a secret encryption key. In the eventual verification scheme embodiment a token is either an encryption of a zero (which represents a free token) or an encryption of a one (which represents a paid token). In other words, TOKENSε{E_{K}(0), E_{K}(1)}. In an exemplary implementation of the eventual verification scheme embodiment the conventional ElGamal public key cryptosystem method is used for E_{K}(•). However, it is noted that the eventual verification scheme embodiment can also be implemented using other semantically secure encryption methods for E_{K}(•) such as the conventional Goldwasser-Micali probabilistic encryption method or the conventional Paillier public key cryptosystem method, among others.

As is appreciated in the art of encryption, the semantically secure encryption method is probabilistic. As a result, if the semantically secure encryption method is used to perform a plurality of independent encryptions of a common data object, each independent encryption will yield a different result. Thus, each independent encryption of a zero will look different and each independent encryption of a one will look different. As a result, if a person were to inspect a given set of tokens he would not be able to discern which tokens in the set are paid tokens and which tokens in the set are free tokens. The secret encryption key K is changed every epoch T by the gaming platform. The secret encryption key K that is used in the epoch (iT, i=1, 2, 3, . . . ) is hereafter sometimes referred to as “Kᵢ”. At the beginning of each new epoch iT, the gaming platform publishes, to both the users and game developers, the secret encryption key K₍ᵢ₋₁₎ that was used during the immediately preceding epoch (i−1)T. Generally speaking and as will be described in more detail hereafter, this routine publication of previously used secret encryption keys allows both the users and game developers to perform token audits.

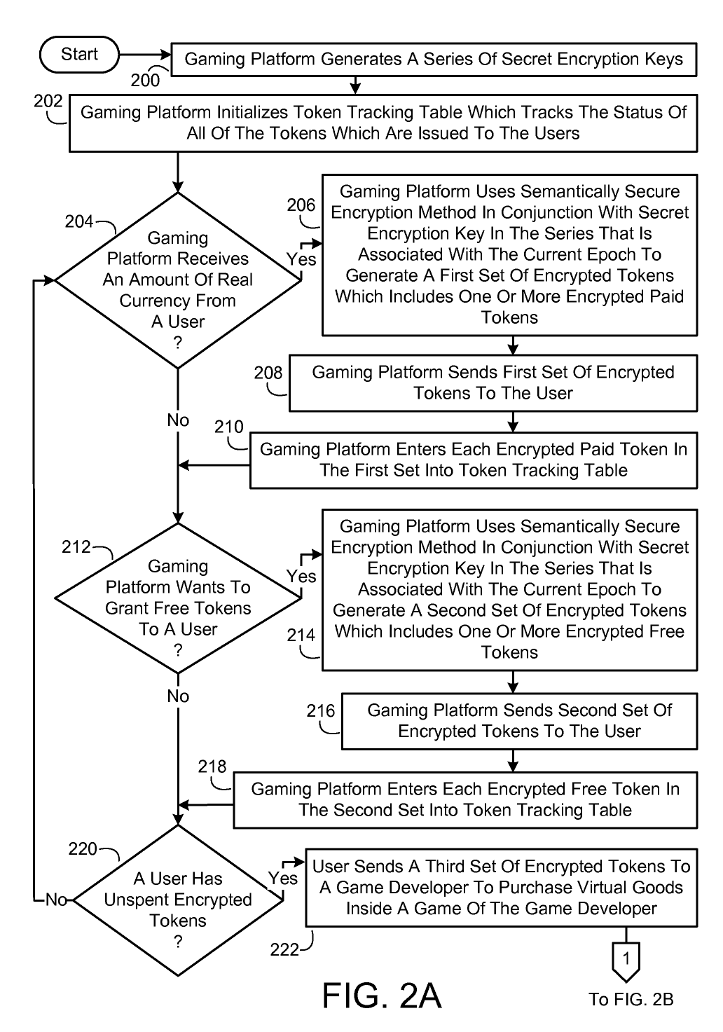

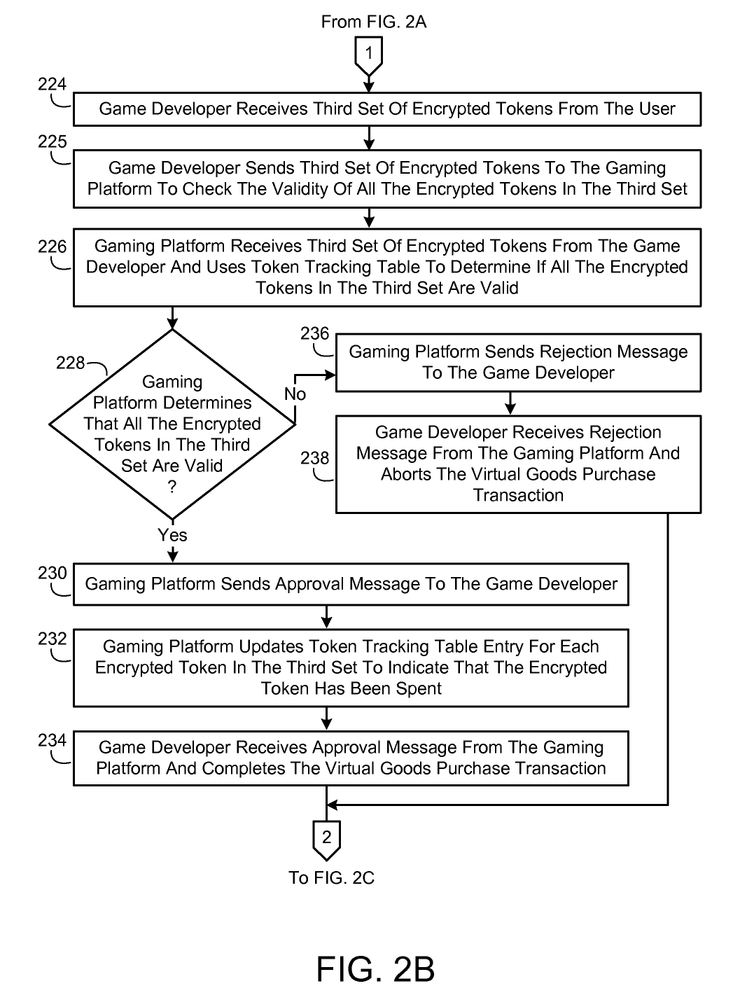

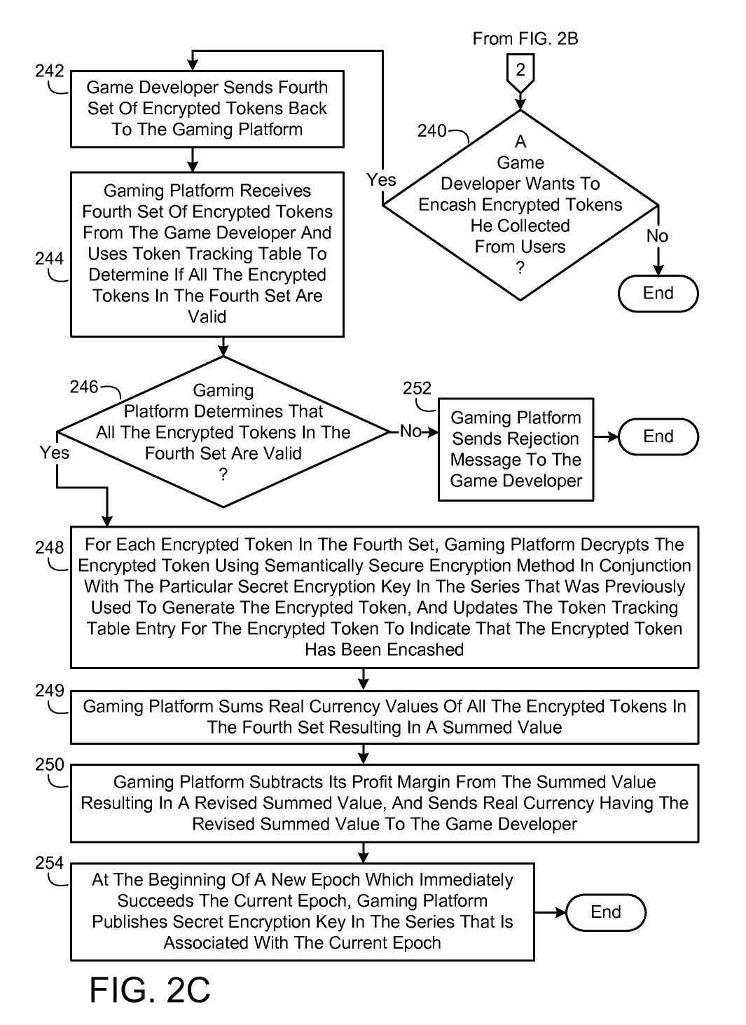

FIGS. 2A-2C illustrate one embodiment, in simplified form, of a process for allowing users to make online purchases using a virtual currency, where this particular embodiment is based on the eventual verification scheme. As exemplified in FIG. 2A, the process starts in block 200 with the gaming platform generating a series of secret encryption keys which can be denoted by ({Kᵢ},iε[1,n]), where each secret encryption key Kᵢ in the series is associated with a different epoch iT in an ongoing sequence of epochs. As will be described in more detail hereafter, the gaming platform can use the semantically secure encryption method in conjunction with a particular secret encryption key Kᵢ to generate one or more encrypted tokens in a particular epoch iT, where each encrypted token can be denoted by (E_{K}_{ᵢ}(•), i). The gaming platform then initializes a token tracking table (block 202) which is hereafter sometimes referred to as “TOKEN_TABLE”. The token tracking table tracks the status of all the tokens which are issued to the users.

The token tracking table can be implemented in various ways. By way of example but not limitation, in an exemplary embodiment of the TVC technique described herein the token tracking table is implemented as follows. Each row in the token tracking table tracks the status of a different token that has been issued to a given user. A first column in the token tracking table includes information that uniquely identifies each token. A second column in the token tracking table includes information that specifies whether or not the token has been spent. A third column in the token tracking table includes information that specifies whether or not the token has been encashed. Thus, the token tracking table can be given by the following equation:

TOKEN_TABLE={TOKEN,Spent?,Encashed?}. (5)

In an exemplary embodiment of the TVC technique a zero in the second column of the token tracking table indicates that the token has not yet been spent, and a zero in the third column of the token tracking table indicates that the token has not yet been encashed. A one in the second column of the token tracking table indicates that the token has already been spent, and a one in the third column of the token tracking table indicates that the token has already been encashed. Alternate embodiments of the TVC technique are also possible which employ other values for these indicators.

Referring again to FIG. 2A, whenever the gaming platform receives an amount of real currency from a user wanting to purchase tokens (block 204, Yes) (i.e., whenever a user initiates a PURCHASE(U,MONEY) transaction), the following actions take place. The gaming platform uses the semantically secure encryption method in conjunction with the secret encryption key Kᵢ in the series that is associated with the current epoch (hereafter sometimes simply referred to as the “current secret encryption key K_{c}”) to generate a first set of encrypted tokens which includes one or more encrypted paid tokens whose combined real currency value equals the amount of real currency received from the user wanting to purchase tokens (block 206). In other words, the gaming platform uses the current secret encryption key K_{c} to generate MONEY number of encryptions of a one in order to produce a set of encrypted tokens which can be given by the equation TOKENS={E_{K}_{_{c}}(1), E_{K}_{_{c}}(1), . . . , E_{K}_{_{c}}(1)}. The gaming platform then sends the first set of encrypted tokens to the user wanting to purchase tokens (block 208). The gaming platform then enters each encrypted paid token in the first set into the token tracking table (block 210), where the entry for each encrypted paid token includes information specifying that the token has not yet been spent and the token has not yet been encashed. In other words, for each TOKENεTOKENS the gaming platform performs the following operation:

TOKEN_TABLE=TOKEN_TABLE∪{TOKEN,0,0}. (6)

Referring again to FIG. 2A, whenever the gaming platform wants to grant free tokens to a given user (block 212, Yes) (i.e., whenever the gaming platform initiates a GRANT(U) transaction), the following actions take place. The gaming platform uses the semantically secure encryption method in conjunction with the current secret encryption key K_{c} to generate a second set of encrypted tokens which includes one or more encrypted free tokens (block 214). It will be appreciated that the particular number of encrypted free tokens to be generated is determined by the gaming platform based on the aforementioned promotional or reward circumstances. In other words, the gaming platform uses the current secret encryption key K_{c} to generate one or more encryptions of a zero in order to produce a set of encrypted tokens which can be given by the equation TOKENS={E_{K}_{_{c}}(0), E_{K}_{_{c}}(0), . . . , E_{K}_{_{c}}(0)}. The gaming platform then sends the second set of encrypted tokens to the given user (block 216). The gaming platform then enters each encrypted free token in the second set into the token tracking table (block 218), where the entry for each encrypted free token includes information specifying that the token has not yet been spent and the token has not yet been encashed. In other words, for each TOKENεTOKENS the gaming platform performs the operation of equation (6) above.

Referring again to FIG. 2A and as exemplified in FIG. 2B, whenever a user has unspent encrypted tokens (block 220, Yes) and wants to use them to purchase virtual goods inside a game they are playing which was developed by a given game developer (i.e., whenever the user initiates a SPEND(U,GD,TOKENS) transaction with the game developer), the following actions take place. The user sends a third set of encrypted tokens to the game developer to purchase the virtual goods inside the game of the game developer (block 222), where the third set includes a prescribed number of encrypted tokens equaling the published token cost of the virtual goods. It will be appreciated that the third set of encrypted tokens can be made up of any combination of encrypted paid tokens and encrypted free tokens. The game developer then receives the third set of encrypted tokens from the user (block 224) and sends it to the gaming platform in order to check the validity of all the encrypted tokens in the third set (block 225). The gaming platform then receives the third set of encrypted tokens from the game developer and uses the token tracking table to determine if all the encrypted tokens in the third set are valid (block 226).

Referring again to FIG. 2B, the determination of whether or not all the encrypted tokens in the third set are valid (block 228) is made by determining if each of the encrypted tokens in the third set is present in the token tracking table, and also determining if any of the encrypted tokens in the third set has already been spent. Whenever the gaming platform determines that each of the encrypted tokens in the third set is present in the token tracking table, and none of the encrypted tokens in the third set has been spent, the gaming platform determines that all of the encrypted tokens in the third set are valid (block 228, Yes). A given encrypted token in the third set is determined to be invalid when the gaming platform determines that either the encrypted token is not present in the token tracking table, or the encrypted token has already been spent.

Referring again to FIG. 2B, whenever the gaming platform determines that all the encrypted tokens in the third set are valid (block 228, Yes), the gaming platform sends an approval message to the game developer (block 230) and updates the token tracking table entry for each encrypted token in the third set to indicate that the encrypted token has been spent (block 232) (i.e., the table entry is updated as {TOKEN, 1,0}). The game developer then receives the approval message from the gaming platform and completes the virtual goods purchase transaction (block 234). Whenever the gaming platform determines that one or more of the encrypted tokens in the third set are invalid (block 228, No), the gaming platform sends a rejection message to the game developer (block 236). The game developer then receives the rejection message from the gaming platform and aborts the virtual goods purchase transaction (block 238).

As exemplified in FIG. 2C, whenever a game developer wants to encash encrypted tokens he collected from one or more users (block 240, Yes), (i.e., whenever the game developer initiates an ENCASH(GD,TOKENS) transaction with the gaming platform), the following actions take place. The game developer sends a fourth set of encrypted tokens he collected from the one or more users back to the gaming platform (block 242). The gaming platform then receives the fourth set of encrypted tokens from the game developer and uses the token tracking table to determine if all the encrypted tokens in the fourth set are valid (block 244).

Referring again to FIG. 2C, the determination of whether or not all the encrypted tokens in the fourth set are valid (block 246) is made by determining if each of the encrypted tokens in the fourth set is present in the token tracking table, and also determining if any of the encrypted tokens in the fourth set has already been encashed. Whenever the gaming platform determines that each of the encrypted tokens in the fourth set is present in the token tracking table, and none of the encrypted tokens in the fourth set has been encashed, the gaming platform determines that all of the encrypted tokens in the fourth set are valid (block 246, Yes). A given encrypted token in the fourth set is determined to be invalid when the gaming platform determines that either the encrypted token is not present in the token tracking table, or the encrypted token has already been encashed.

Referring again to FIG. 2C, whenever the gaming platform determines that all of the encrypted tokens in the fourth set are valid (block 246, Yes), for each encrypted token in the fourth set, the gaming platform decrypts the encrypted token using the semantically secure encryption method in conjunction with the particular secret encryption key Kᵢ in the series that was previously used to generate the encrypted token (where this decryption recovers the real currency value of the encrypted token), and updates the token tracking table entry for the encrypted token to indicate that the encrypted token has been encashed (block 248) (i.e., the table entry is updated as {TOKEN, 1,1}). The gaming platform then sums the real currency values of all the encrypted tokens in the fourth set resulting in a summed value (block 249). The gaming platform then subtracts its profit margin from the summed value resulting in a revised summed value, and sends real currency having the revised summed value to the game developer (block 250). Whenever the gaming platform determines that one or more of the encrypted tokens in the fourth set are invalid (block 246, No), the gaming platform sends a rejection message to the game developer (block 252).

Referring again to FIG. 2C, at the beginning of a new epoch which immediately succeeds the current epoch, the gaming platform publishes the secret encryption key Kᵢ in the series that is associated with the current epoch (block 254). In other words, at the beginning of each new epoch iT, the gaming platform publishes, to both the users and game developers, the secret encryption key K₍ᵢ₋₁₎ that was used during the immediately preceding epoch (i−1)T. Generally speaking and as will now be described in more detail, this routine publication of previously used secret encryption keys allows the conservation and indistinguishability security properties to be verified by the users and game developers at the end of any given epoch iT without having to implicitly trust the gaming platform. With regard to the users' verification of these properties, this secret encryption key publication allows the user wanting to purchase tokens (i.e., the user who paid the amount of real currency to the gaming platform to purchase tokens, and in exchange received the first set of encrypted tokens from the gaming platform) to verify that the first set of encrypted tokens has the proper real currency value. More particularly, this user can decrypt each of the one or more encrypted paid tokens in the first set using the semantically secure encryption method in conjunction with the published secret encryption key in order to verify that the combined real currency value of the one or more encrypted paid tokens equals the amount of real currency he paid (assuming of course that the user did not spend any of these tokens). In a similar manner the users can use the semantically secure encryption method in conjunction with the published encryption key to verify how many unspent free tokens and paid tokens they have at the end of each epoch.

With regard to the game developers' verification of the conservation and indistinguishability security properties, the secret encryption key publication allows the game developer who sent the fourth set of encrypted tokens to the gaming platform for encashment, and in exchange received the real currency having the revised summed value from the gaming platform, to verify that the revised summed value is proper. More particularly, assuming that the game developer knows the gaming platform's published profit margin (which can be published by the gaming platform as described heretofore), the game developer can decrypt each of the encrypted tokens in the fourth set using the semantically secure encryption method in conjunction with the published secret encryption key in order to verify that the real currency he received from the gaming platform is accurate. Additionally, given that nᵢⱼ<Nᵢ denotes the amount of real currency spent during a given epoch iT by each of the users inside a given game of a given game developer j, the game developer j expects to receive encrypted tokens from the users having a real currency value of Σᵢ(nᵢⱼ). Each of the encrypted tokens sent by the users to the game developer j comes with an assurance that it was not already spent because of the token tracking table the gaming platform maintains and the related various encrypted token validations that are performed by the gaming platform. As long as no encrypted tokens are lost between the users and the game developer j, the game developer j can store the encrypted tokens spent by all the users, and can use the published encryption key Kᵢ to verify that these encrypted tokens have a real currency value equal to Σᵢ(nᵢⱼ).

With further regard to the indistinguishability security property, it will be appreciated that this property is a natural consequence of the semantically secure encryption method used by the gaming platform to encrypt both the free tokens and paid tokens which are sent to the users by the gaming platform during a given epoch iT. In other words, since the users and game developers do not have the particular secret encryption key Kᵢ during the epoch iT, neither the users nor the game developers can distinguish one encrypted token from another during the epoch iT. After the epoch iT has ended and secret encryption key Kᵢ has been published by the gaming platform, the gaming platform can do various things including, but not limited to, the following. In one implementation of the eventual verification scheme embodiment of the TVC technique described herein, encrypted tokens which have been sent to but not yet been spent by each user can simply expire. In another implementation of the eventual verification scheme embodiment of the TVC technique the gaming platform can renew such encrypted tokens using a new secret encryption key K₍ᵢ₊₁₎.

### 2.3.2 Timely Verification Scheme

This section presents a description of the timely verification scheme embodiment of the TVC technique described herein. As will be appreciated from the more detailed description that follows, the timely verification scheme embodiment achieves both the conservation and indistinguishability security properties at all times since both the users and the game developers can verify these properties immediately upon the completion of any of the aforementioned types of transactions that can take place between the actors. As such, neither the users nor the game developers have to implicitly trust the gaming platform. As will be described in more detail hereafter, the game developers' verification of these properties is conditioned by a privacy policy that prevents the game developers from determining the real currency value of individual tokens (i.e., discriminating between paid tokens and free tokens) until after they are encashed. The privacy policy can also prevent the game developers from encashing individual tokens, or repeatedly querying the value of the same token or the same set of tokens. The privacy policy can also allow the gaming platform to refuse to encash a given set of tokens if the total number of tokens in the set is smaller than a prescribed value. Even though the timely verification scheme embodiment is computationally more expensive than the eventual verification scheme embodiment, the timely verification scheme embodiment is advantageous in that it requires a lesser degree of trust in the gaming platform.

The timely verification scheme embodiment of the TVC technique described herein utilizes a secure additively homomorphic commitment method which is hereafter simply referred to as a “commitment method”. Generally speaking and as is appreciated in the arts of cryptology and information security, a commitment method is a protocol that is executed between two or more parties, where a first party commits to a value and keeps the value hidden by computing a function of the value which results in a commitment. The first party then sends the commitment to one or more other parties. Knowledge of the commitment by itself does not allow the other parties to learn anything about the value. At a later time, the first party can reveal the value along with some auxiliary information to the other parties, after which the other parties can use the auxiliary information to check the validity of the revealed value.

More particularly, the commitment method includes three different functions, namely a setup function which is hereafter sometimes referred to as “Setup(•)”, a commit function which is hereafter sometimes referred to as “Commit(•)”, and an open function which is hereafter sometimes referred to as “Open(•)”. The setup function generates a public commitment key which can be used by the first party to commit to a message to the one or more other parties, where this message can be denoted by m. The first party can then run the commit function to commit to the message m, where the commit function outputs a commitment which can be denoted by c. The first party can then send the commitment c to the other parties. At some future time, the first party can allow the other parties to “open” the commitment c by sending the message m along with some auxiliary information (which can be denoted by aux) to the other parties. The other parties can then check the correctness of the commitment c by running the open function.

As is also appreciated in the arts of cryptology and information security, a secure commitment method generally has two security properties, namely a hiding property and a binding property. The hiding property ensures that the other parties cannot learn anything about the message m that was committed to by the first party even after receiving the commitment c from the first party. The binding property ensures that the first party cannot open a different commitment once the commit function has been run. In addition to the hiding and binding properties, the commitment method has another property where a commitment on two different messages m₁ and m₂ can be computed directly from the individual commitments on each of the messages. This other property can be given by the following equation:

Commit(m₁+m₂)=Commit(m₁)\textcircled{•}Commit(m₂). (7)

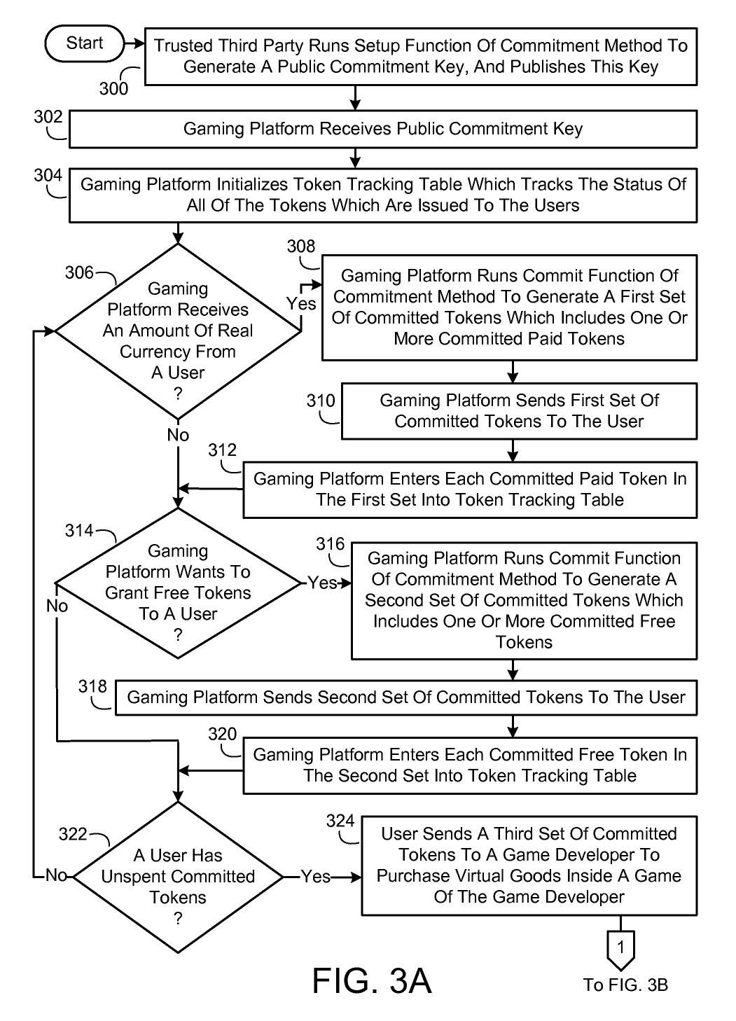

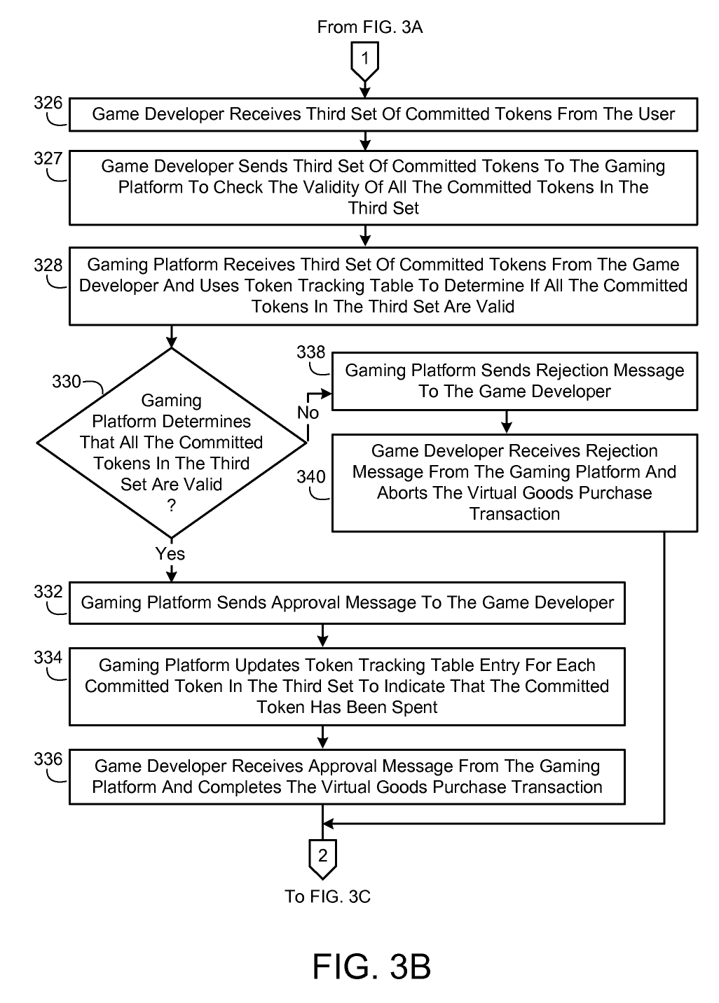

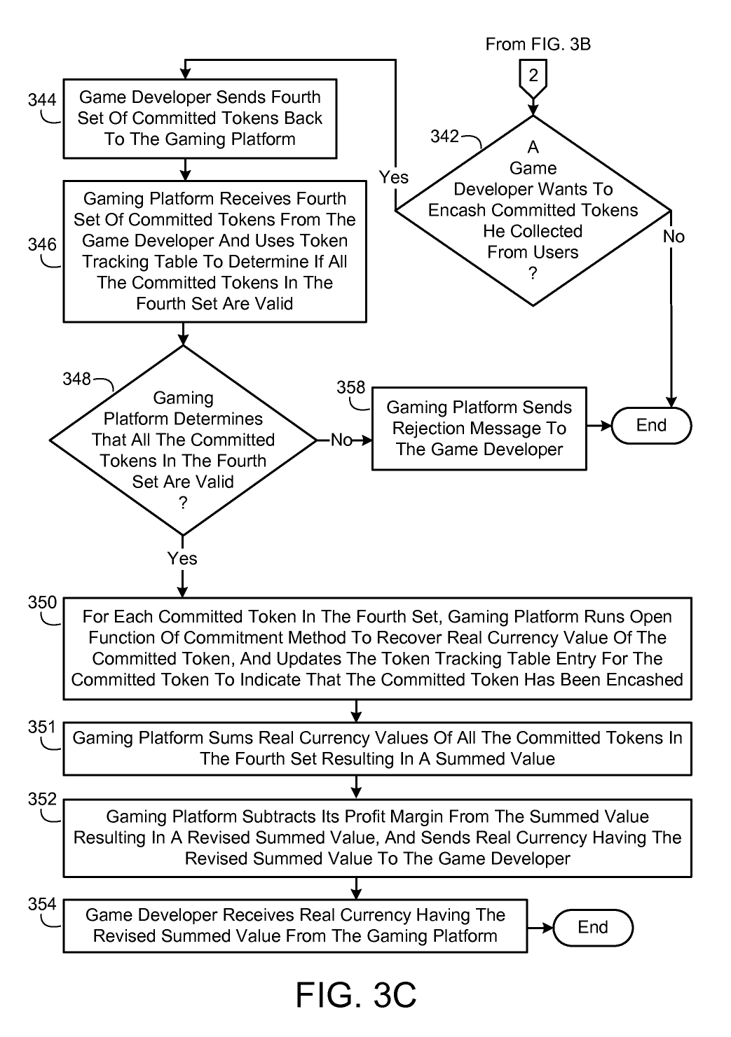

FIGS. 3A-3C illustrate another embodiment, in simplified form, of a process for allowing users to make online purchases using a virtual currency, where this particular embodiment is based on the timely verification scheme. As exemplified in FIG. 3A, the process starts in block 300 with a trusted third party running the setup function (Setup(•)) of the commitment method to generate a public commitment key, and subsequently publishing this key to the gaming platform, users and game developers. In an exemplary implementation of the timely verification scheme embodiment of the TVC technique described herein the conventional Pedersen commitment scheme is used for the commitment method. The Pedersen commitment scheme is advantageous for various reasons including, but not limited to, its computational efficiency.

The Pedersen commitment scheme generally operates as follows. The setup function takes a security parameter k as input and generates a (k+1) bit safe-prime number p which can be given by the equation p=(2q+1), where q is a k-bit prime number. In an exemplary implementation of the timely verification scheme embodiment of the TVC technique described herein a value of 1024 was used for k. The setup function then chooses generators g and h randomly from a group of order q. The chosen generators g and h then become a public commitment key which can be denoted by (g, h). The commit function chooses an element r randomly from a set of integers given by [symbol] _{q} and outputs a commitment c which can be given by the equation c=g^{r}h^{m} mod p. As will be described in more detail hereafter, in the timely verification scheme embodiment of the TVC technique described herein, a paid token is represented by m=1 (i.e., a paid token is a commitment on a one) and a free token is represented by m=0 (i.e., a free token is a commitment on a zero) so that TOKENSε{Commit(0),Commit(1)}. Based on the chosen generators g and h having been published as described heretofore, and the chosen element r having been revealed as will be described in more detail hereafter (i.e., aux=(g,h,r)), the open function will output a one if g^{r}h^{m}=c, and the open function will output a zero if g^{r}h^{m}≠c.

Referring again to FIG. 3A, the gaming platform receives the public commitment key (g, h) that was published by the trusted third party (block 302). The gaming platform then initializes a token tracking table (block 304). The token tracking table tracks the status of all the tokens which are issued to the users. The implementation of the token tracking table has been described heretofore.

Referring again to FIG. 3A, whenever the gaming platform receives a second amount of real currency from a user wanting to purchase tokens (block 306, Yes) (i.e., whenever the user initiates a PURCHASE(U,MONEY) transaction), the following actions take place. The gaming platform runs the commit function (Commit(•) of the commitment method in conjunction with the public commitment key to generate a first set of committed tokens which includes one or more committed paid tokens whose combined real currency value equals the second amount of real currency received from the user wanting to purchase tokens (block 308). In other words, the gaming platform uses the commit function to generate MONEY number of random commitments of a one. In the exemplary implementation of the timely verification scheme embodiment of the TVC technique described herein where the Pedersen commitment scheme is used for the commitment method, the gaming platform chooses MONEY number of elements (r₁, r₂, . . . , r_{MONEY}) randomly from the set of integers given by [symbol] _{q} in order to produce a set of committed tokens which can be given by the following equation:

TOKENS={(hg^{r}^{₁},r₁),(hg^{r}^{₂},r₂), . . . ,(hg^{r}^{_{MONEY}},r_{MONEY})}. (8)

Referring again to FIG. 3A, after generating the first set of committed tokens (block 308), the gaming platform then sends the first set of committed tokens to the user wanting to purchase tokens (block 310). The gaming platform then enters each committed paid token in the first set into the token tracking table (block 312) where the entry for each committed paid token includes information specifying that the token has not yet been spent and the token has not yet been encashed. In other words, for each TOKENεTOKENS the gaming platform performs the operation of equation (6) above. It is noted that in the exemplary implementation of the timely verification scheme embodiment of the TVC technique described herein where the Pedersen commitment scheme is used for the commitment method, since the first set of committed tokens received by the user from the gaming platform includes the elements (r₁, r₂, . . . , r_{MONEY}) that were chosen by the gaming platform (as exemplified by equation (8) above), the user can open each of the committed paid tokens in the first set by running the open function of the Pedersen commitment scheme in conjunction with both the public commitment key (g, h) and the elements (r₁, r₂, . . . , r_{MONEY}) in order to verify that the real currency value of the first set of committed tokens is exactly equal to the second amount of real currency the user sent to the gaming platform.

Referring again to FIG. 3A, whenever the gaming platform wants to grant free tokens to a given user (block 314, Yes) (i.e., whenever the gaming platform initiates a GRANT(U) transaction), the following actions take place. The gaming platform runs the commit function (Commit(•)) of the commitment method in conjunction with the public commitment key to generate a second set of committed tokens which includes one or more committed free tokens (block 316). It will be appreciated that the particular number of committed free tokens to be generated is determined by the gaming platform based on the aforementioned promotional or reward circumstances. In other words, the gaming platform uses the commit function to generate a particular number x of random commitments of a zero. In the exemplary implementation of the timely verification scheme embodiment of the TVC technique described herein where the Pedersen commitment scheme is used for the commitment method, the gaming platform chooses x number of elements (r₁, r₂, . . . , rₓ) randomly from the set of integers given by [symbol] _{q} in order to produce a set of committed tokens which can be given by the following equation:

TOKENS={(g^{r}^{₁},r₁),(g^{r}^{₂},r₂), . . . ,(g^{r}^{ₓ},r^{x})}. (9)

Referring again to FIG. 3A, after generating the second set of committed tokens (block 316),the gaming platform then sends the second set of committed tokens to the given user (block 318). The gaming platform then enters each committed free token in the second set into the token tracking table (block 320), where the entry for each committed free token includes information specifying that the token has not yet been spent and the token has not yet been encashed. In other words, for each TOKENεTOKENS the gaming platform performs the operation of equation (6) above. It is noted that in the exemplary implementation of the timely verification scheme embodiment of the TVC technique described herein where the Pedersen commitment scheme is used for the commitment method, since the second set of committed tokens received by the user from the gaming platform includes the elements (r₁, r₂, . . . , rₓ) that were chosen by the gaming platform (as exemplified by equation (9) above), the user can open each of the committed free tokens in the second set by running the open function of the Pedersen commitment scheme in conjunction with both the public commitment key (g,h) and the elements (r₁, r₂, . . . , rₓ) in order to verify that the real currency value of the second set of committed tokens is zero.

Referring again to FIG. 3A, whenever a user has unspent committed tokens (block 322, Yes) and wants to use them to purchase virtual goods inside a game they are playing which was developed by a given game developers (i.e., whenever the user initiates a SPEND(U,GD,TOKENS) transaction with the game developer), the following actions take place. The user sends a third set of committed tokens to the game developer to purchase the virtual goods inside the game of the game developer (block 324), where this third set includes a number y of committed tokens equaling the published token cost of the virtual goods, but this third set does not include the elements (rᵢ's) of the committed tokens therein. In other words, in the exemplary implementation of the timely verification scheme embodiment of the TVC technique described herein where the Pedersen commitment scheme is used for the commitment method, the third set of committed tokens can be given by the following equation:

TOKENS={g^{r}^{₁},g^{r}^{₂}, . . . ,g^{r}^{_{y}}}. (10)

It will be appreciated that the third set of committed tokens can be made up of any combination of committed paid tokens and committed free tokens. However, since the third set of committed tokens set does not include the elements (rᵢ's) of the committed tokens therein, the game developer is unable to open the committed tokens therein and thus is unable to identify whether they are paid tokens or free tokens.

As exemplified in FIG. 3B, the game developer then receives the third set of committed tokens from the user (block 326) and sends it to the gaming platform in order to check the validity of all the committed tokens in the third set (block 327). The gaming platform then receives the third set of committed tokens from the game developer and uses the token tracking table to determine if all the committed tokens in the third set are valid (block 328). The determination of whether or not all the committed tokens in the third set are valid (block 330) is made by determining if each of the committed tokens in the third set is present in the token tracking table, and also determining if any of the committed tokens in the third set has already been spent. Whenever the gaming platform determines that each of the committed tokens in the third set is present in the token tracking table, and none of the committed tokens in the third set has been spent, the gaming platform determines that all of the committed tokens in the third set are valid (block 330, Yes). A given committed token in the third set is determined to be invalid when the gaming platform determines that either the committed token is not present in the token tracking table, or the committed token has already been spent.

Referring again to FIG. 3B, whenever the gaming platform determines that all of the committed tokens in the third set are valid (block 330, Yes), the gaming platform sends an approval message to the game developer (block 332) and updates the token tracking table entry for each committed token in the third set to indicate that the committed token has been spent (block 334) (i.e., the table entry is updated as {TOKEN,1,0}). The game developer then receives the approval message from the gaming platform and completes the virtual goods purchase transaction (block 336). Whenever the gaming platform determines that one or more of the committed tokens in the third set are invalid (block 330, No), the gaming platform sends a rejection message to the game developer (block 338). The game developer then receives the rejection message from the gaming platform and aborts the virtual goods purchase transaction (block 340).

As exemplified in FIG. 3C, whenever a game developer wants to encash committed tokens he collected from one or more users (block 342, Yes), (i.e., whenever the game developer initiates an ENCASH(GD,TOKENS) transaction with the gaming platform), the following actions take place. The game developer sends an fourth set of committed tokens he collected from the one or more users back to the gaming platform (block 344). It will be appreciated that the fourth set of committed tokens can be made up of any combination of committed paid tokens and committed free tokens. The gaming platform then receives the fourth set of committed tokens from the game developer and uses the token tracking table to determine if all the committed tokens in the fourth set are valid (block 346). The determination of whether or not all the committed tokens in the fourth set are valid (block 348) is made by determining if each of the committed tokens in the fourth set is present in the token tracking table, and also determining if any of the committed tokens in the fourth set has already been encashed. Whenever the gaming platform determines that each of the committed tokens in the fourth set is present in the token tracking table, and none of the committed tokens in the fourth set has been encashed, the gaming platform determines that all of the committed tokens in the fourth set are valid (block 348, Yes). A given committed token in the fourth set is determined to be invalid when the gaming platform determines that either the committed token is not present in the token tracking table, or the committed token has already been encashed.

Referring again to FIG. 3C, whenever the gaming platform determines that one or more of the committed tokens in the fourth set are invalid (block 348, No), the gaming platform sends a rejection message to the game developer (block 358). Whenever the gaming platform determines that all of the committed tokens in the fourth set are valid (block 348, Yes), for each committed token in the fourth set, the gaming platform runs the open function (Open(•)) of the commitment method in conjunction with the public commitment key to recover the real currency value of the committed token, and updates the token tracking table entry for the committed token to indicate that the committed token has been encashed (block 350) (i.e., the table entry is updated as {TOKEN,1,1}). The gaming platform then sums the real currency values of all the committed tokens in the fourth set resulting in a summed value (block 351). The gaming platform then subtracts its profit margin from the summed value resulting in a revised summed value, and sends real currency having the revised summed value to the game developer (block 352). The game developer then receives the real currency having the revised summed value from the gaming platform (block 354). It is noted that in the exemplary implementation of the timely verification scheme embodiment of the TVC technique described herein where the Pedersen commitment scheme is used for the commitment method, the gaming platform does not reveal the elements (rᵢ's) of the individual committed tokens that it encashed to the game developer as part of this particular transaction.

Whenever the total number of committed tokens in the fourth set exceeds a parameter specified by the aforementioned privacy policy, the gaming platform can send information to the game developer which allows the game developer to open the committed tokens in the fourth set in order to verify that the real currency he received from the gaming platform is accurate. In one embodiment of the TVC technique described herein the opening of the committed tokens in the fourth set can be performed by the game developer individually by running the open function of the commitment method. More particularly, the gaming platform can reveal the element rᵢ which the gaming platform used to generate each committed token in the fourth set (refer to equations (8) and (9) above) by sending a fifth set of the elements to the game developer, where the total number of elements in the fifth set equals the total number of committed tokens in the fourth set.

In an alternate embodiment of the TVC technique described herein where the Pedersen commitment scheme is used for the commitment method, the opening of the committed tokens in the fourth set can be performed by the game developer in aggregate by exploiting the homomorphic property of the commitment method. More particularly, the gaming platform can send an aggregate open key to the game developer where this key allows the game developer to open the aggregate of all the committed tokens in the fourth set. The aggregate open key can be denoted by R and can be given by the equation R=Σᵢrᵢ. It will be appreciated that having the aggregate open key R allows the game developer to open the aggregate of the committed tokens in the fourth set by running the open function of the Pedersen commitment scheme in conjunction with both the public commitment key and R in order to verify that the real currency he received from the gaming platform is accurate.

2.3.3 Timely Verification Scheme with Non-Repudiation

This section presents a description of the non-repudiation scheme embodiment of the TVC technique described herein. Generally speaking and as will be described in more detailed hereafter, the non-repudiation scheme embodiment of the TVC technique is an extension of the timely verification scheme embodiment of the TVC technique which utilizes conventional digital signatures in each transaction between the actors in order to achieve the non-repudiation security property (in addition to achieving both the conservation and indistinguishability properties at all times). More particularly, in the non-repudiation scheme embodiment each of the actors involved in a given transaction utilizes a conventional digital signature method to append a digital signature onto each individual message they are sending, where a given digital signature on a given message m is hereafter sometimes referred to as “σ(m)”. In an exemplary implementation of the non-repudiation scheme embodiment the conventional ElGamal digital signature method is used for the digital signature method. However, it is noted that the non-repudiation scheme embodiment can also be implemented using other digital signature methods. As is appreciated in the art of digital signatures, the party who receives a digitally signed message can use the digital signature to validate that the message was sent by a known party and was not altered in transit.

The following is a description of how the PURCHASE(U,MONEY) transaction between the gaming platform and a given user is extended to achieve the non-repudiation security property for this transaction. After the gaming platform runs the commit function of the commitment method in conjunction with the public commitment key to generate the first set of committed tokens (which as described heretofore includes one or more committed paid tokens whose combined real currency value equals the second amount of real currency received from the user wanting to purchase tokens), the gaming platform appends a digital signature onto each committed paid token. In other words, in the exemplary implementation of the timely verification scheme embodiment of the TVC technique described herein where the Pedersen commitment scheme is used for the commitment method, the first set of committed tokens which is produced by the gaming platform can be given by the following equation:

$$\begin{matrix}TOKENS = \{ {c}_{1} = ( {hg}^{{r}_{1}} , {r}_{1} ) , σ ( {c}_{1} ) , {c}_{2} \\ = ( {hg}^{{r}_{2}} , {r}_{2} ) , σ ( {c}_{2} ) , … , {c}_{MONEY} \\ = ( {hg}^{{r}_{MONEY}} , {r}_{MONEY} ) σ ( {c}_{MONEY} ) \} .\end{matrix} \qquad ( 11 )$$

After the gaming platform sends the first set of committed tokens to the user wanting to purchase tokens, this user sends a digitally signed message back to the gaming platform acknowledging that he received the first set of committed tokens, and the gaming platform receives this digitally signed message from this user.

The following is a description of how the GRANT(U) transaction between the gaming platform and a given user is extended to achieve the non-repudiation security property for this transaction. After the gaming platform runs the commit function of the commitment method in conjunction with the public commitment key to generate the second set of committed tokens (which as described heretofore includes one or more committed free tokens), the gaming platform appends a digital signature onto each committed free token. In other words, in the exemplary implementation of the timely verification scheme embodiment of the TVC technique described herein where the Pedersen commitment scheme is used for the commitment method, the second set of committed tokens which is produced by the gaming platform can be given by the following equation:

$$\begin{matrix}TOKENS = \{ {c}_{1} = ( {g}^{{r}_{1}} , {r}_{1} ) , σ ( {c}_{1} ) , {c}_{2} \\ = ( {g}^{{r}_{2}} , {r}_{2} ) , σ ( {c}_{2} ) , … , {c}_{x} = ( {g}^{{r}_{x}} , {r}_{x} ) , σ ( {c}_{x} ) \} .\end{matrix} \qquad ( 12 )$$

After the gaming platform sends the second set of committed tokens to the given user, the given user sends a digitally signed message back to the gaming platform acknowledging that he received the second set of committed tokens, and the gaming platform receives this digitally signed message from the given user.

The following is a description of how the SPEND(U,GD,TOKENS) transaction between a given game developer and a given user is extended to achieve the non-repudiation security property for this transaction. After the game developer receives the approval message from the gaming platform (i.e., after all the committed tokens in the third set are determined to be valid by the gaming platform), the game developer sends a digitally signed message to the given user acknowledging that the game developer received the third set of committed tokens from the given user. After the game developer has completed the virtual goods purchase transaction and the given user has received the virtual goods, the given user sends a digitally signed message back to the game developer acknowledging that the given user received the virtual goods.

The following is a description of how the ENCASH(GD,TOKENS) transaction between a given game developer and the gaming platform is extended to achieve the non-repudiation security property for this transaction. After the gaming platform receives the fourth set of committed tokens from the game developer who wants to encash all the committed tokens in the fourth set, the gaming platform sends a digitally signed message back to the game developer acknowledging that the fourth set of committed tokens was received. After the game developer verifies that the real currency having the revised summed value he received from the gaming platform is accurate, the game developer can send a digitally signed message back to the gaming platform acknowledging that the game developer received this real currency and it is accurate. The gaming platform will then receive this digitally signed message from the game developer.

### 3.0 Additional Embodiments

While the TVC technique has been described by specific reference to embodiments thereof, it is understood that variations and modifications thereof can be made without departing from the true spirit and scope of the TVC technique. By way of example but not limitation, rather than the conventional Pedersen commitment scheme being used for the commitment method in the timely verification scheme and non-repudiation scheme embodiments of the TVC technique described herein, alternate implementations of these embodiment are possible where other secure additively homomorphic commitment methods are be used for the commitment method such as the conventional Abe-Cramer-Fehr non-interactive distributed-verifier proofs method or the conventional Chaum-Evertse-VanDeGraaf protocol for demonstrating possession of discrete logarithms, among others.

Furthermore, in addition to the gaming platform maintaining the aforementioned token tracking table which tracks the status of all the tokens which are issued to the users, the users and game developers can also maintain their own tables (or like mechanisms) which track the status of tokens from their own independent perspectives. Yet furthermore, in addition to the gaming platform being able to issue tokens to certain users free of charge based on the circumstances described heretofore, a given gaming platform can also issue tokens to certain users free of charge based on its own prescribed circumstances. In this case, the gaming platform would track the free tokens it issues and remove such free tokens from any set of tokens it sends to the gaming platform for validation or encashment.

It is also noted that any or all of the aforementioned embodiments can be used in any combination desired to form additional hybrid embodiments. Although the TVC technique embodiments have been described in language specific to structural features and/or methodological acts, it is to be understood that the subject matter defined in the appended claims is not necessarily limited to the specific features or acts described heretofore. Rather, the specific features and acts described heretofore are disclosed as example forms of implementing the claims.

### 4.0 Computing Environment

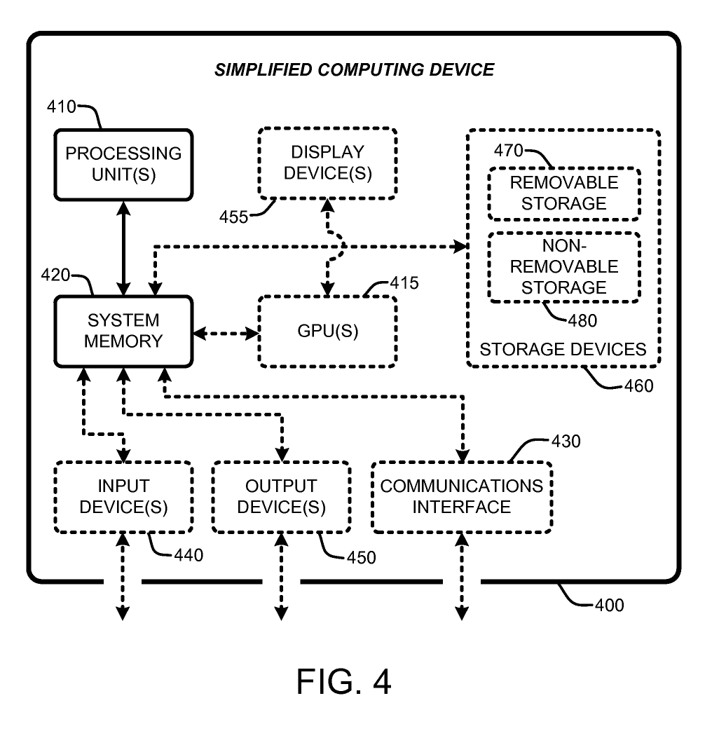

The TVC technique embodiments described herein are operational within numerous types of general purpose or special purpose computing system environments or configurations. FIG. 4 illustrates a simplified example of a general-purpose computer system on which various embodiments and elements of the TVC technique, as described herein, may be implemented. It should be noted that any boxes that are represented by broken or dashed lines in FIG. 4 represent alternate embodiments of the simplified computing device, and that any or all of these alternate embodiments, as described below, may be used in combination with other alternate embodiments that are described throughout this document.

For example, FIG. 4 shows a general system diagram showing a simplified computing device 400. Such computing devices can be typically be found in devices having at least some minimum computational capability, including, but not limited to, personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to implement the TVC technique embodiments described herein, the device should have a sufficient computational capability and system memory to enable basic computational operations. In particular, as illustrated by FIG. 4, the computational capability is generally illustrated by one or more processing unit(s) 410, and may also include one or more graphics processing units (GPUs) 415, either or both in communication with system memory 420. Note that that the processing unit(s) 410 may be specialized microprocessors (such as a digital signal processor (DSP), a very long instruction word (VLIW) processor, or other micro-controller) or can be conventional central processing units (CPUs) having one or more processing cores including, but not limited to, specialized GPU-based cores in a multi-core CPU.

In addition, the simplified computing device of FIG. 4 may also include other components, such as, for example, a communications interface 430. The simplified computing device of FIG. 4 may also include one or more conventional computer input devices 440 (e.g., pointing devices, keyboards, audio input devices, video input devices, haptic input devices, devices for receiving wired or wireless data transmissions, and the like). The simplified computing device of FIG. 4 may also include other optional components, such as, for example, one or more conventional computer output devices 450 (e.g., display device(s) 455, audio output devices, video output devices, devices for transmitting wired or wireless data transmissions, and the like). Note that typical communications interfaces 430, input devices 440, output devices 450, and storage devices 460 for general-purpose computers are well known to those skilled in the art, and will not be described in detail herein.

The simplified computing device of FIG. 4 may also include a variety of computer readable media. Computer readable media can be any available media that can be accessed by computer 400 via storage devices 460, and includes both volatile and nonvolatile media that is either removable 470 and/or non-removable 480, for storage of information such as computer-readable or computer-executable instructions, data structures, program modules, or other data. By way of example but not limitation, computer readable media may include computer storage media and communication media. Computer storage media includes, but is not limited to, computer or machine readable media or storage devices such as digital versatile disks (DVDs), compact discs (CDs), floppy disks, tape drives, hard drives, optical drives, solid state memory devices, random access memory (RAM), read-only memory (ROM), electrically erasable programmable read-only memory (EEPROM), flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, and the like, can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves. Combinations of the any of the above should also be included within the scope of communication media.

Furthermore, software, programs, and/or computer program products embodying the some or all of the various embodiments of the TVC technique described herein, or portions thereof, may be stored, received, transmitted, or read from any desired combination of computer or machine readable media or storage devices and communication media in the form of computer executable instructions or other data structures.

Finally, the TVC technique embodiments described herein may be further described in the general context of computer-executable instructions, such as program modules, being executed by a computing device. Generally, program modules include routines, programs, objects, components, data structures, and the like, that perform particular tasks or implement particular abstract data types. The TVC technique embodiments may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Additionally, the aforementioned instructions may be implemented, in part or in whole, as hardware logic circuits, which may or may not include a processor.

Wherefore, what is claimed is:

1. A computer-implemented process for allowing users to make online purchases using a virtual currency, comprising:
using a computer to perform the following process actions:
generating a series of secret encryption keys, wherein each secret encryption key in the series is associated with a different epoch in an ongoing sequence of epochs;
initializing a token tracking table which tracks the status of all the tokens which are issued to the users; and
whenever an amount of real currency is received from a user wanting to purchase tokens,
using a semantically secure encryption method in conjunction with the secret encryption key in the series that is associated with the current epoch to generate a first set of encrypted tokens comprising one or more encrypted paid tokens whose combined real currency value equals the amount of real currency received from the user wanting to purchase tokens,
sending the first set of encrypted tokens to the user wanting to purchase tokens, and
entering each encrypted paid token in the first set into the token tracking table, wherein the entry for each encrypted paid token comprises information specifying that said token has not yet been spent and said token has not yet been encashed.

2. The process of claim 1, wherein the semantically secure encryption method comprises one of:
an ElGamal public key cryptosystem method; or
a Goldwasser-Micali probabilistic encryption method; or
a Paillier public key cryptosystem method.

3. The process of claim 1, further comprising an action of granting free tokens to a given user, wherein said granting comprises the actions of:
using the semantically secure encryption method in conjunction with the secret encryption key in the series that is associated with the current epoch to generate a second set of encrypted tokens comprising one or more encrypted free tokens;
sending the second set of encrypted tokens to the given user; and
entering each encrypted free token in the second set into the token tracking table, wherein the entry for each encrypted free token comprises information specifying that said token has not yet been spent and said token has not yet been encashed.

4. The process of claim 1, further comprising the actions of:
receiving a third set of encrypted tokens from a game developer wanting to check the validity thereof, wherein the game developer received the third set of encrypted tokens from a user wanting to purchase virtual goods inside a game of the game developer;
using the token tracking table to determine if all the encrypted tokens in the third set are valid;
whenever it is determined that all the encrypted tokens in the third set are valid,
sending an approval message to the game developer, and
updating the token tracking table entry for each encrypted token in the third set to indicate that said token has been spent; and
whenever it is determined that one or more of the encrypted tokens in the third set are invalid, sending a rejection message to the game developer.

5. The process of claim 4, wherein the process action of using the token tracking table to determine if all the encrypted tokens in the third set are valid comprises the actions of:
determining if each of the encrypted tokens in the third set is present in the token tracking table; and
determining if any of the encrypted tokens in the third set has already been spent.

6. The process of claim 1, further comprising the actions of:
receiving a fourth set of encrypted tokens from a game developer, wherein the game developer collected the encrypted tokens in the fourth set from one or more users and wants to encash all said encrypted tokens;
using the token tracking table to determine if all the encrypted tokens in the fourth set are valid;
whenever it is determined that all the encrypted tokens in the fourth set are valid,
for each encrypted token in the fourth set, decrypting said token using the semantically secure encryption method in conjunction with the particular secret encryption key in the series that was previously used to generate said token, and updating the token tracking table entry for said token to indicate that said token has been encashed, wherein the decryption of said token recovers a real currency value of said token,
summing the real currency values of all the encrypted tokens in the fourth set resulting in a summed value,
subtracting a profit margin from the summed value resulting in a revised summed value, and
sending real currency having the revised summed value to the game developer; and
whenever it is determined that one or more of the encrypted tokens in the fourth set are invalid, sending a rejection message to the game developer.

7. The process of claim 6, wherein the process action of using the token tracking table to determine if all the encrypted tokens in the fourth set are valid comprises the actions of:
determining if each of the encrypted tokens in the fourth set is present in the token tracking table; and
determining if any of the encrypted tokens in the fourth set has already been encashed.

8. The process of claim 6, further comprising an action of, at the beginning of a new epoch which immediately succeeds the current epoch, publishing the secret encryption key in the series that is associated with the current epoch, wherein said publication,
allows the user wanting to purchase tokens to decrypt each of the one or more encrypted paid tokens using the semantically secure encryption method in conjunction with said published secret encryption key in order to verify that the combined real currency value of the one or more encrypted paid tokens equals the amount of real currency paid, and
allows the game developer to decrypt each encrypted token in the fourth set using the semantically secure encryption method in conjunction with said published secret encryption key in order to verify that the real currency received is accurate.

9. A computer-implemented process for allowing users to make online purchases using a virtual currency, comprising:
using a computer to perform the following process actions:
receiving a public commitment key having been generated and subsequently published by a trusted third party, wherein the trusted third party generated said key by running a setup function of a secure additively homomorphic commitment method;
initializing a token tracking table which tracks the status of all the tokens which are issued to the users; and
whenever an amount of real currency is received from a user wanting to purchase tokens,
running a commit function of the commitment method in conjunction with said key to generate a first set of committed tokens comprising one or more committed paid tokens whose combined real currency value equals the amount of real currency received from the user wanting to purchase tokens,
sending the first set of committed tokens to the user wanting to purchase tokens, and
entering each committed paid token in the first set into the token tracking table, wherein the entry for each committed paid token comprises information specifying that said token has not yet been spent and said token has not yet been encashed.

10. The process of claim 9, further comprising an action of granting free tokens to a given user, wherein said granting comprises the actions of:
running the commit function of the secure additively homomorphic commitment method in conjunction with the public commitment key to generate a second set of committed tokens comprising one or more committed free tokens;
sending the second set of committed tokens to the given user; and
entering each committed free token in the second set into the token tracking table, wherein the entry for each committed free token comprises information specifying that said token has not yet been spent and said token has not yet been encashed.

11. The process of claim 9, further comprising the actions of:
receiving a third set of committed tokens from a game developer wanting to check the validity thereof, wherein the game developer received the third set of committed tokens from a user wanting to purchase virtual goods inside a game of the game developer;
using the token tracking table to determine if all the committed tokens in the third set are valid;
whenever it is determined that all the committed tokens in the third set are valid,
sending an approval message to the game developer, and
updating the token tracking table entry for each committed token in the third set to indicate that said token has been spent; and
whenever it is determined that one or more of the committed tokens in the third set are invalid, sending a rejection message to the game developer.

12. The process of claim 11, wherein the process action of using the token tracking table to determine if all the committed tokens in the third set are valid comprises the actions of:
determining if each of the committed tokens in the third set is present in the token tracking table; and
determining if any of the committed tokens in the third set has already been spent.

13. The process of claim 9, further comprising the actions of:
receiving a fourth set of committed tokens from a game developer, wherein the game developer collected the committed tokens in the fourth set from one or more users and wants to encash all said committed tokens;
using the token tracking table to determine if all the committed tokens in the fourth set are valid;
whenever it is determined that all the committed tokens in the fourth set are valid,
for each committed token in the fourth set, running an open function of the secure additively homomorphic commitment method in conjunction with the public commitment key to recover a real currency value of said token, and updating the token tracking table entry for said token to indicate that said token has been encashed,
summing the real currency values of all the committed tokens in the fourth set resulting in a summed value,
subtracting a profit margin from the summed value resulting in a revised summed value, and
sending real currency having the revised summed value to the game developer; and
whenever it is determined that one or more of the committed tokens in the fourth set are invalid, sending a rejection message to the game developer.

14. The process of claim 13, wherein the process action of using the token tracking table to determine if all the committed tokens in the fourth set are valid comprises the actions of:
determining if each of the committed tokens in the fourth set is present in the token tracking table; and
determining if any of the committed tokens in the fourth set has already been encashed.

15. The process of claim 13, wherein the secure additively homomorphic commitment method comprises a Pedersen commitment scheme.

16. The process of claim 13, further comprising an action of, whenever the total number of committed tokens in the fourth set exceeds a parameter specified by a privacy policy, sending information to the game developer which allows the game developer to open the committed tokens in the fourth set to verify that the real currency received is accurate, wherein said opening of said committed tokens is performed either individually by running the open function of the commitment method, or in aggregate by exploiting the homomorphic property of the secure additively homomorphic commitment method.

17. A computer-implemented process for allowing users to make online purchases using a virtual currency, comprising:
using a computer to perform the following process actions:
receiving a public commitment key having been generated and subsequently published by a trusted third party, wherein the trusted third party generated said key by running a setup function of a secure additively homomorphic commitment method;
initializing a token tracking table which tracks the status of all the tokens which are issued to the users; and
whenever an amount of real currency is received from a user wanting to purchase tokens,
running a commit function of the commitment method in conjunction with said key to generate a first set of committed tokens comprising one or more committed paid tokens whose combined real currency value equals the amount of real currency received from the user wanting to purchase tokens,
appending a digital signature onto each committed paid token,
sending the first set of committed tokens to the user wanting to purchase tokens,
receiving a digitally signed message from the user wanting to purchase tokens acknowledging that the user received the first set of committed tokens, and
entering each committed paid token in the first set into the token tracking table, wherein the entry for each committed paid token comprises information specifying that said token has not yet been spent and said token has not yet been encashed.

18. The process of claim 17, further comprising an action of granting free tokens to a given user, wherein said granting comprises the actions of:
running the commit function of the secure additively homomorphic commitment method in conjunction with the public commitment key to generate a second set of committed tokens comprising one or more committed free tokens;
appending a digital signature onto each committed free token;
sending the second set of committed tokens to the given user;
receiving a digitally signed message from the given user acknowledging that the given user received the second set of committed tokens; and
entering each committed free token in the second set into the token tracking table, wherein the entry for each committed free token comprises information specifying that said token has not yet been spent and said token has not yet been encashed.

19. The process of claim 17, further comprising the actions of:
receiving a third set of committed tokens from a game developer, wherein the game developer collected the committed tokens in the third set from one or more users and wants to encash all said committed tokens;
sending a digitally signed message to the game developer acknowledging that the third set of committed tokens was received;
using the token tracking table to determine if all the committed tokens in the third set are valid; and
whenever it is determined that all the committed tokens in the third set are valid,
for each committed token in the third set, running an open function of the secure additively homomorphic commitment method in conjunction with the public commitment key to recover a real currency value of said token, and updating the token tracking table entry for said token to indicate that said token has been encashed,
summing the real currency values of all the committed tokens in the third set resulting in a summed value,
subtracting a profit margin from the summed value resulting in a revised summed value, and
sending real currency having the revised summed value to the game developer.

20. The process of claim 19, wherein the secure additively homomorphic commitment method comprises a Pedersen commitment scheme, further comprising the actions of:
whenever the total number of committed tokens in the third set exceeds a parameter specified by a privacy policy, sending a fourth set of elements to the game developer, wherein,
the total number of elements in the fourth set equals the total number of committed tokens in the third set,
each element in the fourth set is associated with a different committed token in the third set and was chosen by the commit function of the Pedersen commitment scheme when said committed token was generated, and
the fourth set of elements allows the game developer to open each of the committed tokens in the third set by running the open function of the Pedersen commitment scheme in conjunction with both the public commitment key and said fourth set in order to verify that the real currency the game developer received is accurate; and
whenever the game developer verifies that the real currency received is accurate, receiving a digitally signed message from the game developer acknowledging that the game developer received the real currency having the revised summed value and it is accurate.
